(19) United States
(12) Patent Application Publication
(10) Pub. No.: US 2010/0277298 A1
(43) Pub. Date: Nov. 4, 2010

(54) DETECTION SYSTEM AND METHOD THEREOF

(75) Inventors: DANIEL LEONG, Singapore (SG); CHEE KENG YEO, Singapore (SG); YEW KWANG LOW, Singapore (SG); KOK WEE YEO, Singapore (SG)

Correspondence Address: DELPHI TECHNOLOGIES, INC, M/C 480-410-202, PO BOX 5052, TROY, MI, 48007, US

(73) Assignee: DELPHI TECHNOLOGIES, INC., Troy, MI (US)

(21) Appl. No.: 12/432,050

(22) Filed: Apr. 29, 2009

(51) Int. Cl. B60Q 1/00

(52) U.S. Cl. 340/438

(57) ABSTRACT

A detection system and method for detecting an object adjacent a vehicle is provided, wherein the detection system includes a plurality of thermopile sensors and a processor. The plurality of thermopile sensors include a first thermopile sensor and second thermopile sensor. The detection system further includes a processor in communicative connection with the plurality of thermopile sensors, the processor being adapted to receive a signal from a vehicle component as to an operating condition of the vehicle, wherein the processor is configured to command at least one of the first and second thermopile sensors to auto-align, and determine a detection of an object that is adjacent to the vehicle as a function one of a plurality of detection modes, the plurality of detection modes being based upon movement of the vehicle with respect to the vehicle's normal operating position.

### TECHNICAL FIELD

The present invention generally relates to a system and method for detecting an object, and more particularly, a system and method for detecting an object adjacent a vehicle.

### BACKGROUND OF THE INVENTION

Vehicle operators are generally required to negotiate traffic safely when traveling on public roadways. For this reason, cars, trucks and other road-traveling vehicles are typically equipped with mirrors positioned both inside and outside the vehicle. The mirrors allow the driver to see a portion of the roadway behind or beside the host vehicle with only a slight shift of the eyes or turn of the driver's head. If other vehicles are visible, the driver will be suitably alerted and in position to avoid making an inappropriate maneuver, such as a lane change.

Being aware of other vehicles is particularly important when changing lanes on the roadway, either to the left or the right. To change lanes safely the driver needs to ascertain beforehand that there is no obstructive vehicle in the adjacent lane. However, for reasons of geometry the conventional side view mirrors generally only provide a partial view of the space immediately to the side and towards the back of the host vehicle, which needs to be clear for the host vehicle to change lanes. Accordingly, a space unviewable via the mirrors, commonly called the “blind spot,” is therefore typically checked by the driver physically turning his or her head to the side so that the blind spot space can be viewed directly. When it is confirmed that the space is clear and that there is no other vehicle fast approaching, the driver can maneuver the host vehicle into the desired lane.

Various detection systems have been proposed for detecting objects in a vehicle blind spot region. Many of the proposed detection systems employ various types of sensors for detecting an object and alerting the driver of the host vehicle of the presence of the object in the blind spot region.

Exemplary detection systems for detecting objects in a blind spot of a vehicle are disclosed in U.S. Pat. No. 5,668,539 entitled “THERMAL EMITTED RADIATION DETECTION DEVICE,” and U.S. Pat. No. 6,753,766, entitled “DETECTING DEVICE AND METHOD OF USING SAME,” both of which are hereby entirely incorporated herein by reference. The approaches disclosed in the aforementioned patents generally employ a plurality of infrared (IR) sensors, such as thermopile sensors, to detect changes in a thermal scene along the side of a host vehicle to detect the presence of a thermal emitting object, such as another vehicle (automobile), in the blind spot region of the host vehicle. This prior technique employs identical IR sensors positioned at predetermined locations along the side of the host vehicle to sense thermal temperature in two predetermined locations. Based on the speed of the host vehicle, the amount of time shift that is necessary to have data from the same physical area at the two different location points in time is determined. If there is a temperature increase in one of the thermal images, then it is assumed to be heat emitted from another vehicle. The heat could be heat reflected from the roadway underneath the other vehicle or heat generated at the interface of the roadway and tires of the other vehicle. Further, such IR sensors generally need to be mounted to the vehicle in narrow tolerances to obtain the predetermined positioning so that the time shift can be accurately determined.

### SUMMARY OF THE INVENTION

According to one aspect of the present invention, a detection system for detecting an object adjacent a vehicle includes a plurality of thermopile sensors and a processor. The plurality of thermopile sensors include a first thermopile and a second thermopile. The processor is in communicative connection with the plurality of thermopile sensors, the processor being adapted to receive a signal from a vehicle component as to an operating condition of the vehicle, wherein the processor is configured to command at least one of the plurality of thermopile sensors to auto-align, and determine a detection of an object that is adjacent to the vehicle as a function one of a plurality of detection modes, the plurality of detection mode being based upon movement of the vehicle with respect to the vehicle's normal operating position.

According to another aspect of the present invention, a method for detecting an object adjacent a vehicle includes the steps of supplying electrical power to a thermopile sensor, and auto-aligning the at least one thermopile sensor. The method further includes the steps of determining a direction of movement of the vehicle with respect to the vehicle's normal operating position, and operating the at least one thermopile sensor in one of a plurality of modes as a function of the determined direction of movement of the vehicle.

According to yet another aspect of the present invention, a method for detecting an object adjacent a vehicle includes the steps of providing at least one thermopile sensor, supplying electrical power to the thermopile sensor, auto-aligning the at least one thermopile sensor, and determining if the vehicle is moving forward with respect to the vehicle's operating position. The method further includes the steps of determining if the vehicle is moving at a speed greater than a threshold value, if it is determined that the vehicle is moving forward with respect to the vehicle's normal operating position, and determining if the vehicle is moving backwards with respect to the vehicle's normal operating position. Additionally, the method includes the steps of operating the thermopile sensor in a first detection mode to detect objects in a first area adjacent the vehicle when the vehicle is moving forward with respect to the vehicle's normal operating position, and operating the thermopile sensor in a second detection mode to detect objects in a second area adjacent the vehicle when the vehicle is moving forward with respect to the vehicle's normal operating position.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a top environmental view of a system for detecting an object adjacent a vehicle illustrating exemplary detection areas adjacent the vehicle, in accordance with one embodiment of the present invention;

FIG. 2 is a cross-sectional view of a thermopile sensor, in accordance with one embodiment of the present invention;

FIG. 3 is a block diagram illustrating a system for detecting an object adjacent a vehicle, in accordance with one embodiment of the present invention;

FIG. 4 is a flow chart illustrating a method of auto-aligning and detecting an object adjacent a vehicle, in accordance with one embodiment of the present invention;

FIG. 5 is a top environmental view of a system for detecting an object adjacent a vehicle illustrating exemplary desired detection areas adjacent the vehicle, in accordance with one embodiment of the present invention;

FIG. 6A is an exemplary illustration of an 8×8 thermopile array image taken of a front wheel and engine of a vehicle adjacent to a vehicle including a detection system, in accordance with one embodiment of the present invention;

FIG. 6B is an exemplary illustration of an 8×8 thermopile array image taken of a person adjacent to a vehicle including a detection system, in accordance with one embodiment of the present invention;

FIG. 7A is a flow chart illustrating a method of auto-aligning a thermopile sensor, in accordance with one embodiment of the present invention;

FIG. 7B is a chart illustrating a relationship between pixel values and frequency for a calculated histogram of pixel readings as in the method of FIG. 7A, in accordance with one embodiment of the present invention;

FIG. 8A is a flow chart illustrating a side alert method, in accordance with one embodiment of the present invention;

FIG. 8B is a chart illustrating a relationship between pixel values and frequency for a calculated histogram of pixel readings as in the method of FIG. 8A, in accordance with one embodiment of the present invention;

FIG. 9A is a flow chart illustrating a rear alert method, in accordance with one embodiment of the present invention;

FIG. 9B is a graph illustrating a relationship between pixel values and frequency for a calculated histogram of pixel readings as in the method of FIG. 9A, in accordance with one embodiment of the present invention;

FIG. 10 is a top environmental view of a system for detecting an object adjacent a vehicle illustrating exemplary detection areas adjacent the vehicle, in accordance with an alternate embodiment of the present invention;

FIG. 11 is a top environmental view of a system for detecting an object adjacent a vehicle illustrating exemplary detection areas within a passenger cabin of the vehicle, in accordance with an alternate embodiment of the present invention;

FIG. 12 is a top environmental view of a system for detecting an object adjacent a vehicle illustrating exemplary detection areas within a passenger cabin of the vehicle, in accordance with an alternate embodiment of the present invention; and

FIG. 13 is a top environmental view of a system for detecting an object adjacent a vehicle including a plurality of thermopile sensors that detect conditions of a vehicle tire, in accordance with an alternate embodiment of the present invention.

### DESCRIPTION OF EMBODIMENTS

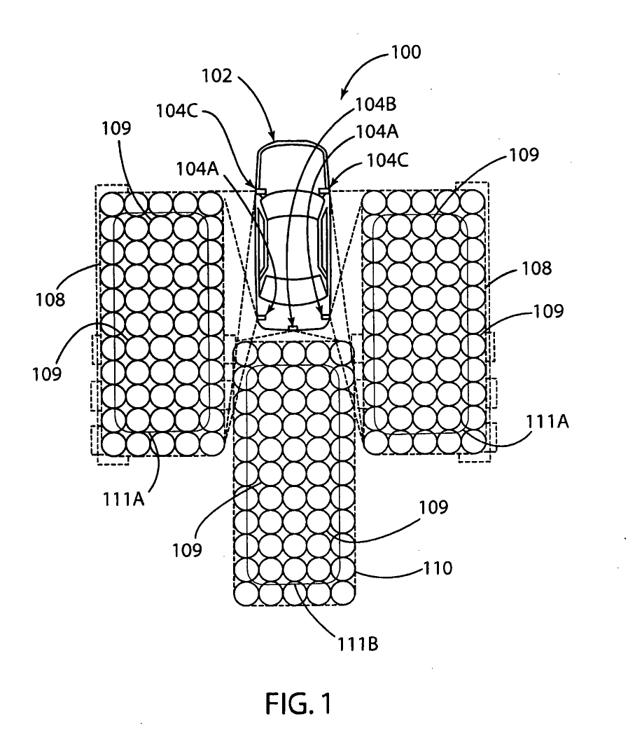

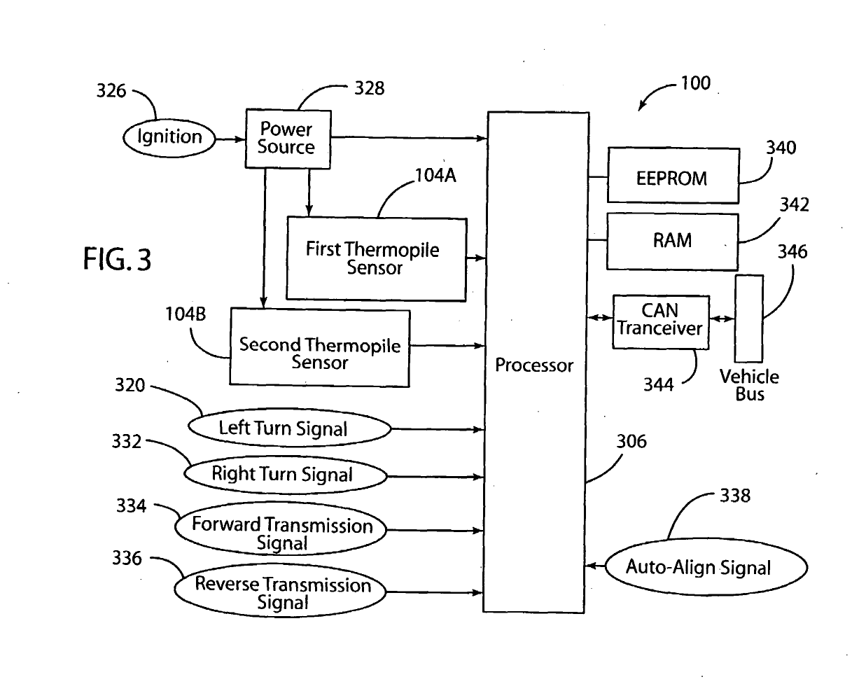

In regards to FIGS. 1-3, a detection system for detecting an object is generally shown in FIGS. 1 and 3 at reference identifier 100. The detection system 100 can be for detecting an object adjacent a vehicle generally indicated at reference identifier 102. The detection system 100 includes a plurality of thermopile sensors generally indicated at reference identifier 104. The plurality of thermopile sensors 104 can include at least a first thermopile sensor 104A and a second thermopile sensor 104B. The detection system 100 further includes a processor 306 (FIG. 3) in communicative connection with the plurality of thermopile sensors 104. The processor is adapted to receive a signal from a vehicle 102 as to an operating condition of the vehicle 102, wherein the processor 306 is configured to command at least one of the first thermopile sensor 104A and the second thermopile sensor 104B to auto-align, and determine a detection of an object that is adjacent to the vehicle 102 as a function of one of a plurality of detection modes. The plurality of detection modes are based upon movement of the vehicle 102 with respect to the vehicle's 102 normal operating position, as described in further detail herein.

Thus, the detection system 100 can implement a plurality of thermopile sensors 104 to detect objects adjacent to the vehicle, such as, but not limited to, a vehicle's 102 blindspot. It should be appreciated by those skilled in the art that an object can include living objects (e.g., humans or animals), inanimate objects (e.g., other vehicles), or a combination thereof. It is described in greater detail below, that the detection system 102 can auto-align at least one thermopile sensor 104, such that the thermopile sensor 104 can be mounted to the vehicle 102 within a greater tolerance than if the sensor 104 is not capable of auto-alignment. It should further be appreciated by those skilled in the art that the vehicle's 102 normal operating position can relate to a typical front end of the vehicle, such that the vehicle 102 moves forward with respect to the vehicle's 102 normal operating position when a transmission of a vehicle is in a forward gear, and the vehicle 102 moves backwards (i.e., reverse) with respect to the vehicle's 102 normal operating position when the transmission is in a reverse gear. For purposes of explanation and not limitation, the detection system 100 is described with respect to the plurality of thermopile sensors 104 that can include the first and second thermopile sensors 104A,104B; however the plurality of thermopile sensors 104 can include additional thermopile sensors, such as, but not limited to, a third thermopile sensor 104C.

According to one embodiment, the processor 306 can be configured to utilize a first detection mode of the plurality of detection modes to detect objects in an area adjacent to the vehicle 102 when the vehicle 102 is moving forward with respect to the vehicle's 102 normal operating position. Thus, the processor 306 can detect objects in a first area, such as, but not limited to, a side-area 108 when the vehicle 102 is moving forward with respect to the vehicle's 102 normal operating position. Typically, the side-area 108 that is monitored when the processor 306 is in the first detection mode is a blind spot of the vehicle 102. According to one embodiment, the vehicle moving forward with respect to the vehicle's 102 normal operating position can be based upon the processor 306 receiving a signal from a transmission of the vehicle 102. However, it should be appreciated by those skilled in the art that the direction of movement the vehicle 102 can be determined in other suitable manners. Further, the first detection mode can be utilized when the vehicle 102 is moving forward at a speed that is greater than a threshold value, as described in greater detail below.

Additionally or alternatively, the processor 306 can be configured to utilize a second detection mode of the plurality of detection modes to detect objects in an area adjacent to the vehicle 102 when the vehicle 102 is moving backwards with respect to the vehicle's 102 normal operating position. Typically, the monitored area when the processor 306 is configured to utilize a second detection mode is a second area, such as, but not limited to a rear-area 110. According to one embodiment, the first area 108 at least partially differs from the second detection area 110.

According to one embodiment, the detection areas 108,110 can be represented or formed by a plurality of detection spots 109. Typically, each detection area 108,110 includes a desired detection area 111A,111B, respectively. The desired detection area 111A can be a function of the intended objects of detection by the respective thermopile sensor 104A,104B. For purposes of explanation and not limitation, the desired detection area 111A for the first thermopile sensor 104A (e.g., blind spot detection) differs from the desired detection area 111B for the second thermopile sensor 104B (e.g., rear-ward object detection).

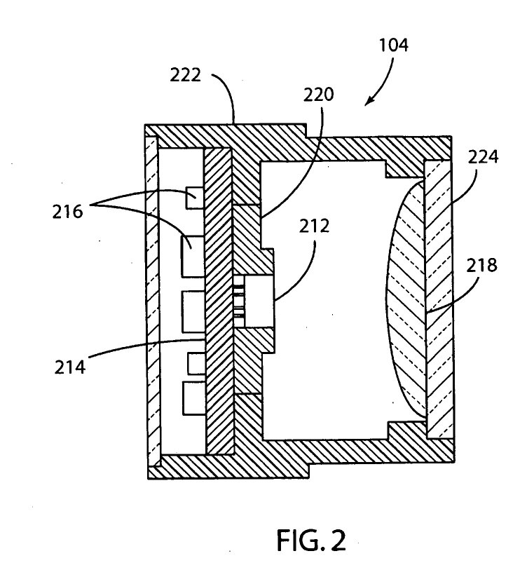

With respect to FIG. 2, a thermopile sensor 104 can include a thermopile array 212, which can be mounted to a controller board 214 that includes electrical components 216. The thermopile sensor 104 can further include a window 218 and a heatsink 220. At least a portion of the thermopile array 212, the controller board 214, the electronic components 216, the window 218, and the heatsink 220, can be enclosed within a housing 222. According to one embodiment, the window can be made of silicon, germanium, calcogenide glass, an infra-red transmission material, or the like. In operation, an infrared-red (IR) radiation can pass through and is focused by a lens 224 and window 218 onto the thermopile array 212. The thermopile sensor 104 can then be used to detect objects adjacent the vehicle 102. Exemplary thermopile sensors are described in U.S. Pat. No. 6,961,006 entitled “OBJECT DETECTION FOR A STOPPED VEHICLE,” U.S. Pat. No. 7,148,482 entitled “MULTIPLE SENSOR THERMAL RADIATION DETECTOR AND METHOD,” and U.S. Patent Application Publication No. 2006/0067378 entitled “APPARATUS AND METHOD FOR THERMAL DETECTION,” all of which are hereby entirely incorporated herein by reference.

According to one embodiment show in FIG. 3, the detection system 100 can include an ignition 326 and a power source 328, wherein when the ignition 326 is activated, the power source 328 supplies power to the first thermopile sensor 104A and the second thermopile sensor 104B. The processor 306 is configured to receive signals communicative from the first thermopile sensor 104A, the second thermopile sensor 104B, other signals from additional vehicle components, or a combination thereof. For purposes of explanation and not limitation, the other vehicle components that provide signals to the processor 306 can include a left turn signal 330, a right turn signal 332, a forward transmission signal 334, a reverse transmission signal 336, and an auto-aligned signal 338. The detection system 100 can further include at least one memory device, which can be, but is not limited to, an electronically erasable programmable read-only memory (EEPROM) 340 that can be configured to store alignment data, other suitable reprogrammable permanent memory, and a random-access memory (RAM) 342 that can be configured to store data when executing an object detection method or sub-routine. The processor 306 can be further configured to communicate with a control area network (CAN) transceiver 344 that communicates with a vehicle bus 346.

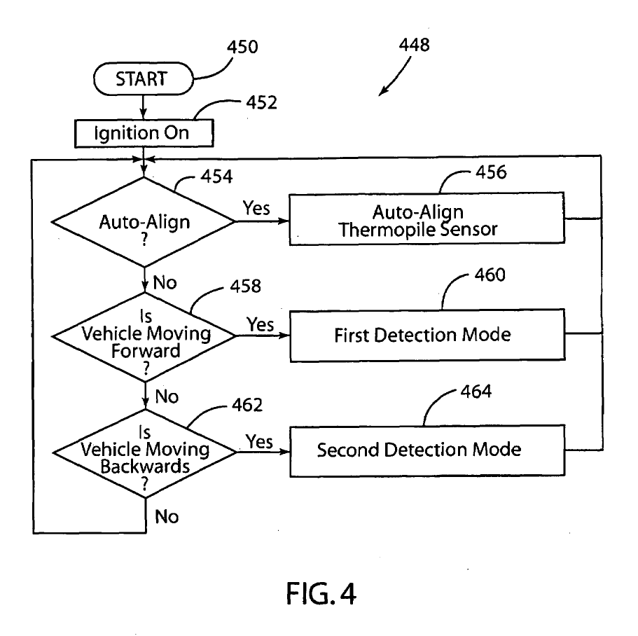

In regards to FIGS. 1, 3, and 4, a method of detecting an object adjacent a vehicle 102 is generally shown in FIG. 4 at reference identifier 448. The method 448 starts at step 450, and proceeds to step 452, wherein the ignition is turned on. At decision step 454 it is determined if at least one of the thermopile sensors 104 is to be auto-aligned. If it is determined at decision step 454 that at least one of the thermopile sensors 104 is to be auto-aligned, then the method 448 proceeds to step 456, wherein at least one of the thermopile sensors 104 is auto-aligned. The method 448 then returns to decision step 454.

However, if it is determined at decision step 454 that at least one of the thermopile sensors 104 is not to be auto-aligned, then the method 448 proceeds to decision step 458. At decision step 458 it is determined if the vehicle 102 is moving forward with respect to the vehicle's 102 normal operating position (e.g., a transmission of the vehicle 102 is in a forward gear). If it is determined at decision step 458 that the vehicle is moving forward with respect to the vehicle's 102 normal operating position, then the method 448 proceeds to step 460. At step 460, the first detection mode is implemented to detect objects adjacent to the vehicle 102, and the method 448 then returns to decision step 454.

If it is determined at decision step 458 that the vehicle is not moving forward with respect to the vehicle's 102 normal operating position, then the method 448 proceeds to decision step 462. At decision step 462, it is determined if the vehicle 102 is moving backwards with respect to the vehicle's 102 normal operating position. If it is determined at decision step 462 that the vehicle is moving backwards with respect to the vehicle's 102 normal operating position, then the method 448 proceeds to step 464, wherein a second detection mode is implemented to detect objects adjacent the vehicle 102. The method 448 then returns to decision step 454. However, if it is determined at decision step 462 that the vehicle 102 is not moving backwards with respect to the vehicle's 102 normal operating position, then the method returns to decision step 454.

It should be appreciated by those skilled in the art that the method 448 is continuously implemented until the vehicle 102 is turned off (e.g., the ignition is turned off). According to one embodiment, it is determined at decision step 454 to auto-align at least one of the thermopile sensors 104 when power is supplied to the thermopile sensor 104 the first time after the thermopile sensor 104 has been mounted to the vehicle 102. Additionally or alternatively, the vehicle 102 can include a button or other suitable input that commands the processor 306 to auto-align at least one thermopile sensor 104 (e.g., the auto-align signal 338). Thus, the user of the vehicle 102 can auto-align at least one of the thermopile sensor 104, at least one of the thermopile sensors 104 can be auto-aligned during vehicle maintenance, the like, or a combination thereof. Typically, it is not determined to auto-align at least one thermopile sensor 104 (step 454) each time the ignition 326 is turned on (step 452), but such an embodiment to auto-align at least one thermopile sensor 104 each time the ignition 326 is turned on (step 452) is within the scope of the present application.

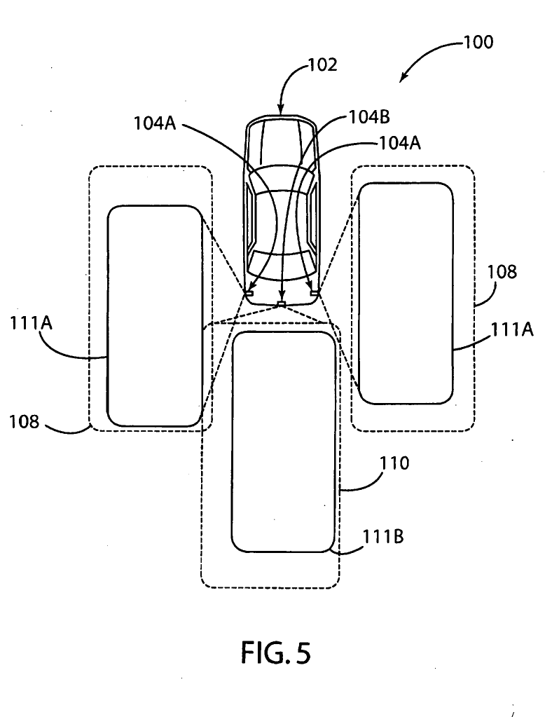

Typically, during assembly, the thermopile sensor 104 is mounted to the vehicle 102 within a manufacturing tolerance; however, the desired detection area 111A,111B is typically off center (FIG. 5) within the side and rear detection areas 108,110, respectively, due to the mounting location of the thermopile sensor 104 on the vehicle 102, even though the thermopile sensor 104 is mounted within the acceptable manufacturing tolerance. Since the detection system 100 is configured to auto-align at least one of the thermopile sensors 104, this off-center alignment of the desired detection area 111A,111B with respect to the side detection area 108 and rear detection area 110, respectively, is acceptable due to the auto-align method then centering the desired detection areas 111A,111B within the respective side and rear detection areas 108,110. Once the thermopile sensors 104 are mounted to the vehicle 102 and auto-aligned, the thermopile sensors 104 can detect objects adjacent the vehicle 102.

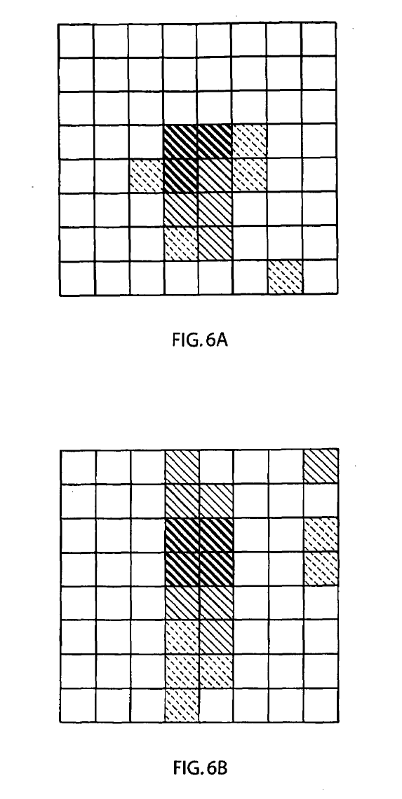

By way of explanation and not limitation, FIG. 6A illustrates an exemplary 8×8 thermopile array image taken of a front wheel and an engine of a vehicle adjacent to the vehicle 102 that contains the thermopile sensor 104. Further, FIG. 6B is an exemplary illustration of an 8×8 thermopile array image taken of a person adjacent to the vehicle 102 that contains thermopile sensor 104. Such exemplary images can then be analyzed by the processor 306 (FIG. 3) to determine if an object is present in the image.

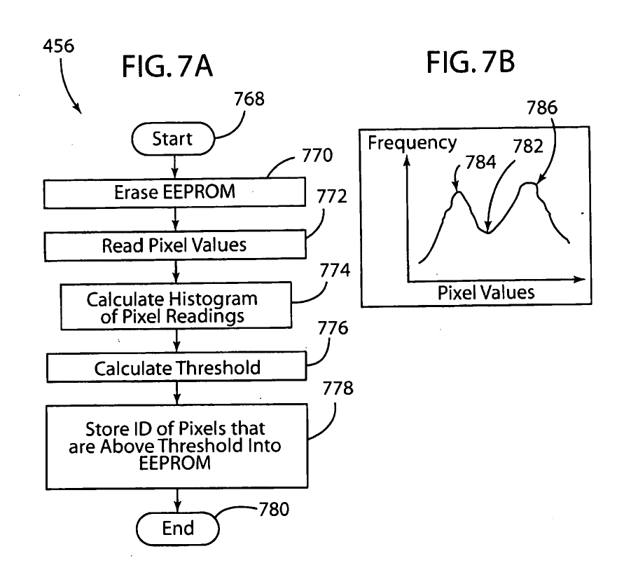

With respect to FIGS. 1-4, 7A, and 7B, a method of auto-aligning at least one thermopile sensor 104 is generally shown in FIG. 7A at reference identifier 456. The method 456 starts at step 768 and proceeds to step 770, wherein the EEPROM 340 is erased. At step 772 pixel values are read, wherein the pixel values correspond to an image obtained from the thermopile sensor 104. At step 774, a histogram of pixel readings is calculated. The method 456 then proceeds to decision step 776, wherein a threshold is calculated. At step 778, the ID of the pixels that are above the threshold are stored into the EEPROM 340. Typically, the pixels that are above the threshold are aligned pixels. The method 456 then ends at step 780.

As to FIG. 7B, an exemplary calculated histogram of pixel readings (step 774) is shown comparing pixel values and frequency. The calculated threshold value is generally indicated at reference identifier 782, which separates ambient areas generally indicated at reference identifier 784 from the detection area generally indicated at reference identifier 786.

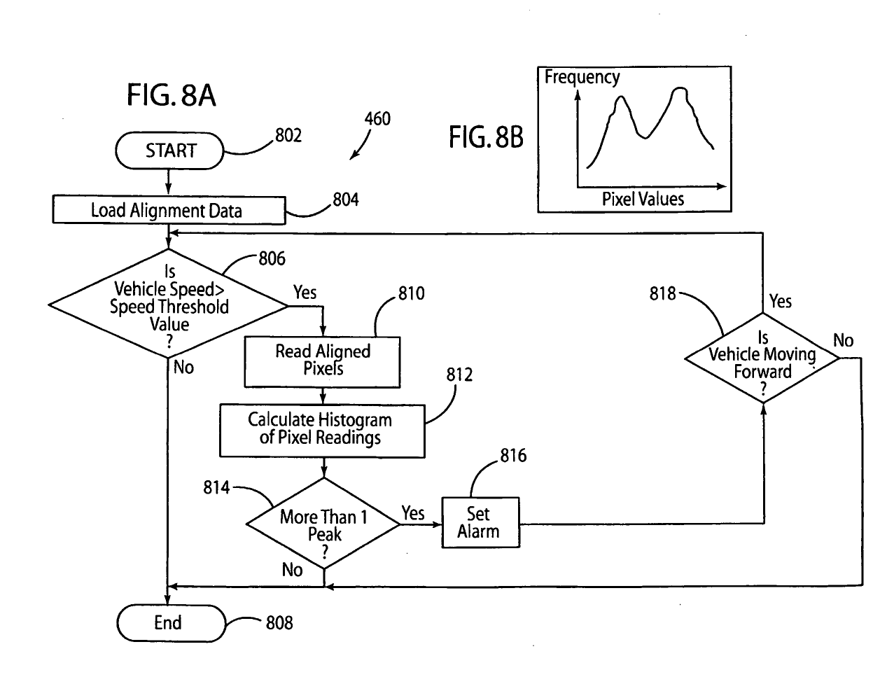

In regards to FIGS. 1-4, 8A, and 8B, a method of a first detection mode to detect objects adjacent to the vehicle 102 is generally shown in FIG. 8A at reference identifier 460. The method 460 starts at step 802, and proceeds to step 804, wherein the alignment data is loaded. Typically, the alignment data that is loaded is based upon the data obtained during the auto-aligned method 456 (FIGS. 4 and 6). The method 460 then proceeds to decision step 806, wherein it is determined if the vehicle's 102 speed is greater than a speed threshold value. It should be appreciated by those skilled in the art that the speed threshold (step 806) differs from the threshold calculated (step 776) during the auto-alignment of at least one thermopile sensor 104. If it is determined at decision step 806 that the vehicle's 102 speed is not greater than the speed threshold value, then the method 460 ends at step 808. If it is determined at decision step 806 that the vehicle's 102 speed is greater than the speed threshold value, then the method 460 proceeds to step 810. According to one embodiment the speed threshold value is 15 mph.

When the method 460 proceeds to step 810, the line pixels are read, and at step 812, a histogram of pixel readings is calculated. The method 460 then proceeds to decision step 814, wherein it is determined if there is more than one peak in the calculated histogram. If it is determined at decision step 814 that there is not more than one peak in the calculated histogram, then the method 460 ends at step 808. However, if it is determined at decision step 814 that there is more than one peak in the calculated histogram, then the method 460 proceeds to step 816, wherein an alarm is set. At decision step 818 it is determined if the vehicle 102 is moving forwards with respect to the vehicle's 102 normal operating position. If it is determined at decision step 818 that the vehicle 102 is moving forwards with respect to the vehicle's 102 normal operating position, then the method 460 returns to decision step 806. Typically, decision step 818 is included in the method 460 since the method 460 can be continuously performed, such that before the method 460 is performed again, it is determined if the vehicle 102 is still moving forward with respect to a normal operating position. However, if it is determined that the vehicle 102 is not moving backwards with respect to the vehicle's 102 normal operating position, then the method 460 ends at step 808.

As to FIG. 8B, an exemplary calculated histogram of pixel reading (step 812) is shown comparing pixel values and frequency. The peaks of the calculated histogram can then be determined (step 814), as shown in FIG. 8A.

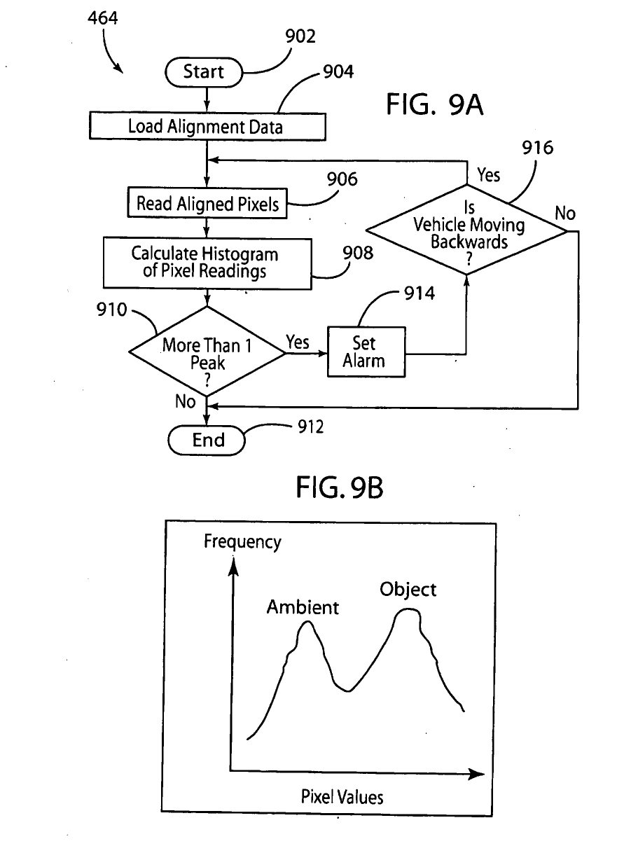

As to FIGS. 1-4, 9A, and 9B, a method of a second detection mode to detect objects adjacent to the vehicle 102 is generally shown in FIG. 9A at reference identifier 464. The method 464 starts at step 902, and proceeds to step 904, wherein alignment data is loaded. Typically, the loaded alignment data is the data obtained from the auto-aligned method 464 (FIG. 6). The method 464 then proceeds to step 906, wherein the aligned pixels are read, and step 908, wherein a histogram of pixel readings is calculated.

At decision step 910, it is determined if there is more than one peak of the calculated histogram. If it is determined that there is not more than one peak at decision step 910 then the method 464 ends at step 912. However, if it is determined at decision step 910 that there is more than one peak in the calculated histogram then the method 464 proceeds to step 914, wherein an alarm is set. At decision step 916, it is determined if the vehicle 102 is moving backwards with respect to the vehicle's 102 normal operating position. If it is determined at decision step 916 that the vehicle 102 is moving backwards with respect to the vehicle's 102 normal operating position, then the method 464 returns to step 906. Typically, decision step 916 is included in the method 460 since the method 460 can be continuously performed, such that before method 460 is performed again, it is determined if the vehicle 102 is still moving backwards with respect to the vehicle's 102 normal operating position. However, if it is determined that the vehicle 102 is not moving backwards with respect to the vehicle's 102 normal operating position, then the method 464 ends at step 912.

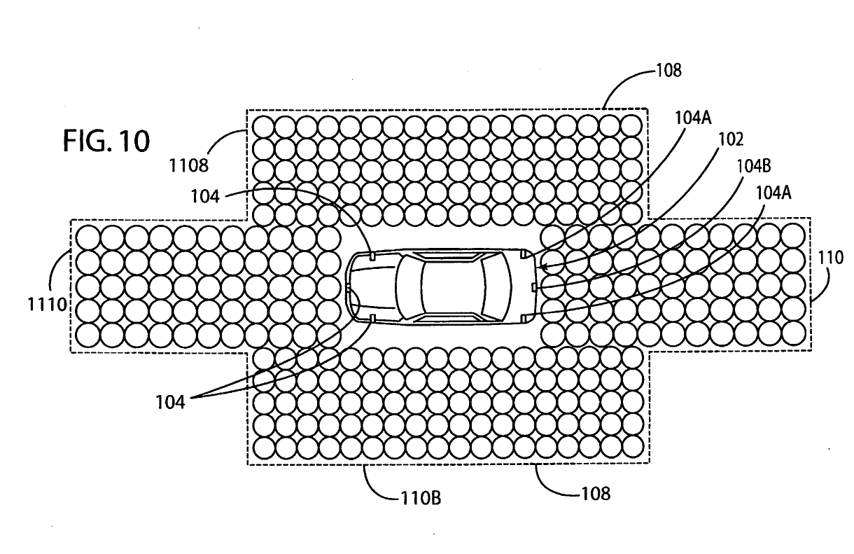

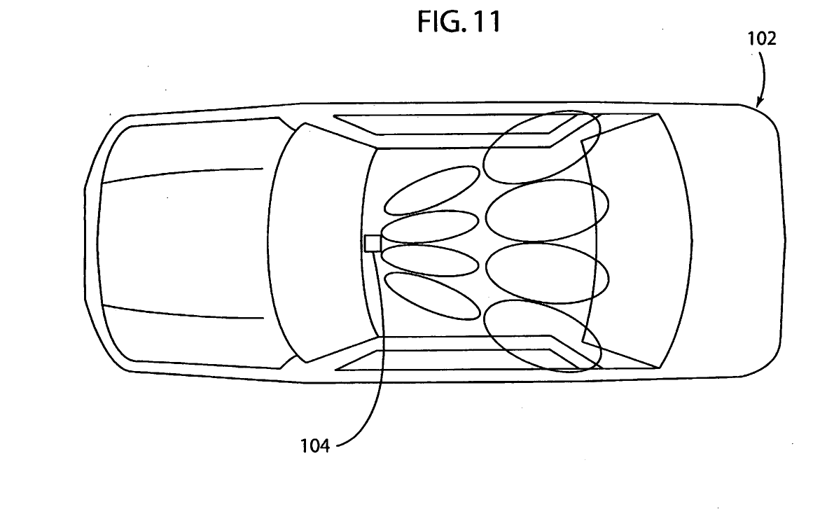

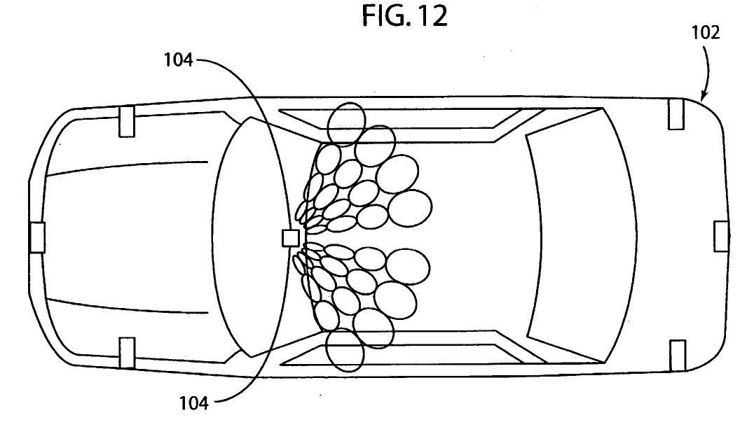

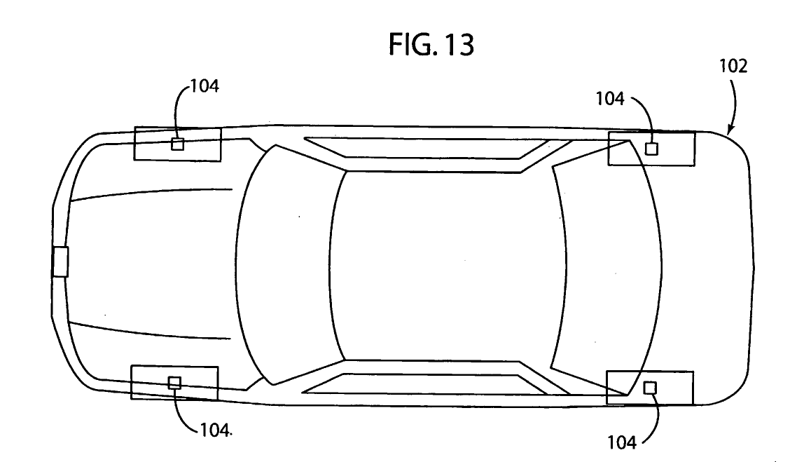

According to one embodiment, the thermopile sensors 104 that are used to detect objects adjacent to the vehicle 102 can also be used for other detection operations. For purposes of explanation and not limitation, the thermopile sensors 104 can be used to determine if an object is present in a front alert zone area 1108 and a pre-collision area 1110 (FIG. 10). According to an alternate embodiment, the thermopile sensors 104 can be used in a climate control detection system (FIG. 11), an occupant position detection system (FIG. 12), or determining a condition of tires on the vehicle 102, (FIG. 13), such as, but not limited to, determining a temperature differential of the tires to detect wear and tear.

Advantageously, the detection system 100 and the method 448 can be used to detect objects adjacent the vehicle 102, wherein the thermopile sensor 104 can be mounted to the vehicle 102 within a greater manufacturing tolerance since the thermopile sensor 104 can be auto-aligned. Additionally, the system 100 and method 448 can be used to detect an object in at least partially different detection areas 108,110 based upon the movement of the vehicle 102 with respect to the vehicle's 102 normal operating position. It should be appreciated by those skilled in the art that addition or alternative advantages may result from the present application. It should further be appreciated by those skilled in the art that the above elements and steps can be combined in alternative ways in various combinations.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A system for detecting an object adjacent a vehicle comprising:
a plurality of thermopile sensors comprising;
a first thermopile sensor; and
a second thermopile sensor; and
a processor in communicative connection with said plurality of thermopile sensors, said processor being adapted to receive a signal from a vehicle component as to an operating condition of the vehicle, wherein said processor is configured to command at least one of said plurality of thermopile sensors to auto-align, and determine a detection of an object that is adjacent the vehicle as a function one of a plurality of detection modes, said plurality of detection modes being based upon movement of the vehicle with respect to the vehicle's normal operating position.

2. The system of claim 1, wherein said processor is configured to utilize a first detection mode of said plurality of detection modes to detect objects in an area adjacent the vehicle when the vehicle is moving forward with respect the vehicle's normal operating position.

3. The system of claim 2, wherein said first detection mode is utilized when the vehicle is moving forward at a speed that is greater than a threshold value.

4. The system of claim 1, wherein said processor is configured to utilize a second detection mode of said plurality of detection modes to detect objects in an area adjacent the vehicle when the vehicle is moving backwards with respect to the vehicle's normal operating position.

5. The system of claim 1, wherein said processor is further configured to utilize a first detection mode of said plurality of detection modes to detect objects in a first area adjacent the vehicle when the vehicle is moving forward with respect to the vehicle's normal operating position, and utilize a second detection mode of said plurality of detection modes to detect objects in a second area adjacent the vehicle when the vehicle is moving backwards with respect to the vehicle's normal operating position, such that said first area is at least partially different than said second area.

6. The system of claim 1, wherein said processor auto-aligns said first thermopile sensor by performing the following steps comprising of:
erasing a memory of said first thermopile sensor;
reading pixel values of said first thermopile sensor;
calculating a histogram of said read pixel values;
calculating a threshold as a function of said calculated histogram;
determining if each of said read pixel values are greater than said calculated threshold value; and
storing an identification of said pixels that are determined as being greater than said threshold value.

7. The system of claim 1, wherein a maximum sensing area of said first thermopile sensor is greater than a monitored area of said first thermopile sensor.

8. The system of claim 1, wherein at least one of said first and second thermopile sensors is utilized for detection within a passenger cabin of said vehicle.

9. A method for detecting an object adjacent a vehicle, said method comprising the steps of:
supplying electrical power to a thermopile sensor;
auto-aligning said thermopile sensor;
determining a direction of movement of the vehicle with respect to the vehicle's normal operating position; and
operating said thermopile sensor in one of a plurality of modes as a function of said determined direction of movement of the vehicle.

10. The method of claim 9, wherein said step of operating said thermopile sensor comprises utilizing a first detection mode of said plurality of detection modes to detect objects in an area adjacent the vehicle when the vehicle is moving forward with respect the vehicle's normal operating position.

11. The method of claim 10, wherein said step of utilizing said first detection mode comprises determining if the vehicle is moving forward at a speed that is greater than a threshold value.

12. The method of claim 9, wherein said step of operating said thermopile sensor comprises utilizing a second detection mode of said plurality of detection modes to detect objects in an area adjacent the vehicle when the vehicle is moving backwards with respect to the vehicle's normal operating position.

13. The method of claim 9, wherein said step of operating said thermopile sensor comprises:
utilizing a first detection mode of said plurality of detection modes to detect objects in a first area adjacent the vehicle when the vehicle is moving forward with respect to the vehicle's normal operating position; and
utilizing a second detection mode of said plurality of detection modes to detect objects in a second area adjacent the vehicle when the vehicle is moving backwards with respect to the vehicle's normal operating position, such that said first area is at least partially different than said second area.

14. The method of claim 9, wherein said step of auto-aligning said thermopile sensor comprises the steps of:
erasing a memory of said thermopile sensor;
reading pixel values of said thermopile sensor;
calculating a histogram of said read pixel values;
calculating a threshold as a function of said calculated histogram;
determining if each of said read pixel values are greater than said calculated threshold value; and
storing an identification of said pixels that are determined as being greater than said threshold value.

15. The method of claim 9, wherein a maximum sensing area of said thermopile sensor is greater than a monitored area of said thermopile sensor.

16. The method of claim 9 further comprising the step of utilizing said thermopile sensor for detection within a passenger cabin of the vehicle.

17. A method for detecting an object adjacent a vehicle, said method comprising the steps of:
providing at least one thermopile sensor;
supplying electrical power to said thermopile sensor;
auto-aligning said at least one thermopile sensor;
determining if the vehicle is moving forward with respect to the vehicle's normal operating position;
determining if the vehicle is moving at a speed greater than a threshold value, if it is determined that the vehicle is moving forward with respect to the vehicle's normal operating position;
determining if the vehicle is moving backwards with respect to the vehicle's normal operating position;
operating said thermopile sensor in a first detection mode to detect objects in a first area adjacent the vehicle when the vehicle is moving forward with respect the vehicle's normal operating position; and
operating said thermopile sensor in said second detection mode to detect objects in a second area adjacent the vehicle when the vehicle is moving forward with respect the vehicle's normal operating position.

18. The method of claim 17, wherein said step of automatically aligning said thermopile sensor comprises the steps of:
erasing a memory of said first thermopile sensor;
reading pixel values of said first thermopile sensor;
calculating a histogram of said read pixel values;
calculating a threshold as a function of said calculated histogram;
determining if each of said read pixel values are greater than said calculated threshold value; and
storing an identification of said pixels that are determined as being greater than said threshold value.

19. The method of claim 17, wherein a maximum sensing area of said at least one thermopile sensor is greater than a monitored area of said thermopile sensor.

20. The method of claim 17, wherein said first area of detection at least partially differs from said second area of detection.
